(19) United States
(12) Patent Application Publication
(10) Pub. No.: US 2026/0316848 A1
(43) Pub. Date: Oct. 15, 2026

(54) IMPROVEMENTS TO A TEMPERATURE CONTROLLED ENVIRONMENT IN A STORAGE COMPARTMENT OF A VEHICLE

(71) Applicant: Christopher John WARBURTON, WEST BRADFORD (GB)

(72) Inventor: Christopher John WARBURTON, WEST BRADFORD (GB)

(21) Appl. No.: 19/117,270

(22) PCT Filed: Oct. 26, 2023
(86) PCT No.: PCT/GB2023/052804

§ 371 Date: Mar. 31, 2025

(30) Foreign Application Priority Data
Oct. 27, 2022 (GB) 2215919.8

(51) Int. Cl. B62D 33/04

(52) U.S. Cl. CPC B62D 33/048

(57) ABSTRACT

The invention relates to a vehicle compartment, panels used to form the compartment and vehicle including said compartment. The compartment includes a cavity in which there is provided a thermally controlled, typically chilled or freezing, environment for the transport and storage of items therein. The compartment is formed by a plurality of panels and wherein at least one of said panels includes a core formed of recycled plastics material in a foamed condition and, on at least one external face of said core, there is provided a woven sheet material bonded to said external surface. Typically the said core material and the woven sheet material can be recycled and preferably without the need of separation of the woven material from the core. The panels are provided to be located together at respective interfaces to form the compartment with a floor, roof, side walls, end walls and door access into the said cavity.

The invention to which this application relates is an apparatus for maintaining a temperature controlled environment, most typically a chilled or freezing environment, in a vehicle and particularly to a temperature controlled environment in a storage area of a van or the like.

The use of a cooled environment in a van, commonly known as chilled environment compartments, or frozen environment compartments, to be able to maintain articles, such as foodstuffs, in the required storage conditions, during transport and delivery, is well known.

Conventionally, there is provided a cooling, or a refrigeration unit mounted on the vehicle, typically on the roof of the same, which allows ambient air to be introduced into the apparatus and output into the cooling environment in a cooled condition. The level of cooling can be selected to suit the particular requirements of the vehicle and the contents which need to be stored therein.

While the legal standards for the provision of these vehicles varies from country to country, there is typically, at least a target if not a legally enforceable standard for the performance of the apparatus. Furthermore, increasingly, there is a demand for the operation of the apparatus to have a reduced environmental impact as, conventionally, the apparatus is operated by the power generated by the vehicle and therefore the vehicle is required to be kept running in order for the chilling apparatus to operate. This can therefore result in the vehicle being left running even though the same is not moving.

The applicant, in their co-pending application GB1902029.6 has realised that the conventional means of creating the chilling environment, which typically comprises a frame formed of wooden sheet material onto which is bonded a foam, while structurally efficient, is inefficient in other ways and in particular in terms of the time taken to construct the compartment, the performance of the same and also the fact that the materials used in the construction are not recyclable and therefore generates significant waste material at the end of life. In their co-pending application, the applicant suggests the use of panels formed of recyclable plastic material which is provided in a form of foam which is relatively dense and does provide some level of rigidity. However, it is found that the panels disclosed in the co-pending application, may not have sufficient rigidity so as to create a structurally secure chilled compartment and there may be difficulty in securing the panels in position and, even though the panels may be formed of a relatively dense foam material, the same are still susceptible to damage particularly by the impact on the external surface of the same by goods during use of the vehicle. Thus, while the complete recyclability of the material used in the applicant's co-pending application is of considerable benefit, there are disadvantages of the system disclosed therein.

The aim of the present invention is to provide an improved form of chilled environment and compartment which maintains the benefit of complete or substantially complete recyclability of the materials used whilst, at the same time, increasing the resistance to damage to the panel surfaces during use. A further aim is to provide the panels in a form which allows particular characteristics to be achieved for particular uses and/or locations of the said panels as part of the chilled compartment which is created to thereby improve the rigidity and structural integrity of the chilled environment.

In a first aspect of the invention there is provided a vehicle compartment with a cavity in which there is provided a temperature controlled environment for the transport and/or storage of items therein, said compartment formed by a plurality of panels and wherein at least one of said panels includes a core formed of recycled and/or recyclable plastics material in a foamed condition and, on at least one external face of said core, there is provided an outer layer of sheet material bonded to said external surface of said core.

Preferably, the said sheet material is a woven sheet material, preferably formed of a recyclable plastics material, as is the core, so that, the panel which is formed is entirely, or substantially entirely, recyclable. Typically the material used to form the woven sheet material is itself previously recycled plastics material.

Preferably, the panel is recyclable without the need for separation of the woven sheet material from the core.

In one embodiment, the core is formed as a unitary structure.

In an alternative embodiment, the core is formed by at least two layers of material, with a first layer having a rigidity or strength greater than the other of said layers.

In one embodiment, a plurality of said panels are used in combination to form a chilled environment cavity in the compartment and at least one of said panels is formed with a core of a plurality of layers are located so as to form a stronger floor of the said compartment.

In one embodiment, at least one of said panels includes one or more channels formed therein, said channels formed of a length, dimension and at a location so as to receive therein and act as location means for an edge of another panel. Typically said other panel is located with the first panel at substantially 90 degrees thereto. However, the angle can be adjusted by forming the side walls and/or base of the channel at a selected angle.

In one embodiment, the interface between the said first and other panel is substantially sealed by using a plastics welded material therealong.

Typically, the plastics welded material is of a form so as to be recyclable along with the material used to form said panels and therefore ensure that all, or substantially all, of the chilled environment compartment can be recycled and preferably with a minimum separation of the components being required.

In one embodiment, the said panels are formed with first and second opposing faces and edge faces, with the opposing faces substantially parallel.

In another embodiment, one or more of said panels are formed with said opposing side faces and edge faces and at least one of the said opposing faces is formed to have at least one protruding portion so as to form a three-dimensional shape so that there is a varying width between the opposing faces.

Typically, the said at least one protruding portion on one of the said faces can be located in a cavity or cavities in the frame of the vehicle to which the same is fitted to thereby substantially fill the same and thereby increase the thermal efficiency of the cavity in the compartment.

In one embodiment the said compartment a cavity is defined by a floor panel, first and second side wall panels, a roof panel, an end wall panel and one or more door panels which form an opposing end wall when closed.

In one embodiment the floor panel, first and second side walls panels, roof panel and/or end wall panel may selectively be formed by a plurality of panels which are sealed together.

Typically the panels are oriented such that said woven sheet material layer is located so as to form the surfaces of the respective panels which face inwardly into the cavity. This also increases the resistance of the panels to potentially damaging impact during the loading, transit and unloading of the items into and from the said cavity.

In one embodiment the compartment is located in a storage area of the vehicle and the said panels are located adjacent to the walls of the frame of the said storage area.

In one embodiment the said vehicle is a van or larger vehicle and the storage area is located to the rear of the driver and passenger seats of the said vehicle.

In one embodiment the said compartment is at least partially assembled at a location separate to the vehicle and then fitted into a storage area of the vehicle.

In one embodiment the said compartment is formed by placing the panels and joining the same together inside the storage of the vehicle.

In one embodiment the compartment is provided in the storage area of the vehicle at an instant of time after the vehicle and storage area has been formed.

In a further aspect of the invention there is provided a panel for use in the creation of a compartment, said panel comprising a core formed of recycled and/or recyclable plastics material in a foamed condition and, on at least one external face of said core, there is provided an outer layer of sheet material bonded to said external face.

In one embodiment said sheet material is formed as a woven, recyclable plastics material layer and the core and sheet material layer are recyclable as a unit.

In one embodiment, the said panel is formed with first and second opposing faces and edge faces, with the opposing faces substantially parallel.

In another embodiment, the panel is formed with said opposing side faces and edge faces and at least one of the said opposing faces is formed to have at least one protruding portion so that there is a varying width between the opposing faces.

Typically, the said at least one protruding portions on one of the said faces can be located in a cavity or cavities in the frame of the vehicle to which the same is fitted to thereby substantially fill the same and thereby increase the thermal efficiency of the chilled environment compartment.

In a further aspect of the invention there is provided a vehicle including a temperature controlled cavity within a compartment located in the vehicle formed by a series of panels interconnected to form said compartment and in which items are located and stored in typically a chilled or frozen condition, wherein at least one of said panels are formed with a core and a woven sheet material forming an exterior face of said core.

Typically the vehicle includes at least one refrigeration unit which is provided so as to introduce chilled air into the said cavity, typically via connecting passage between the refrigeration unit and the cavity.

Specific embodiments of the invention are now described with reference to the accompanying drawings wherein:

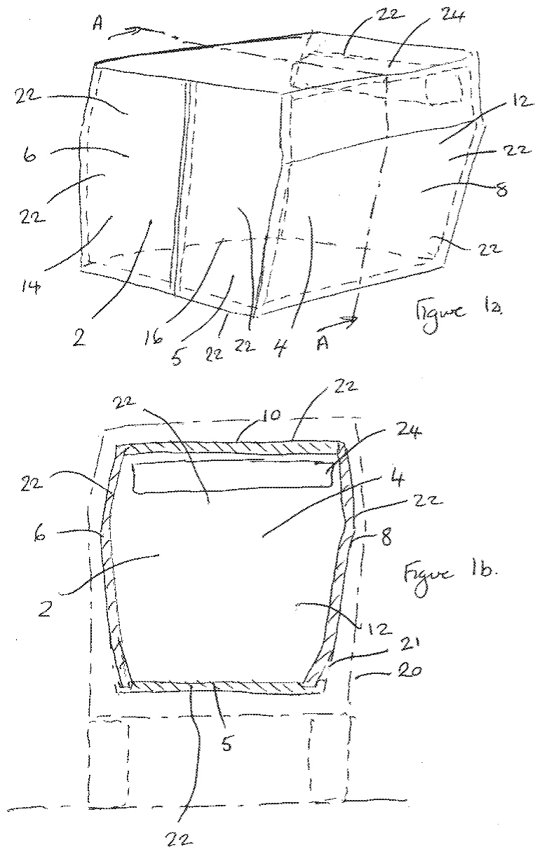

FIGS. 1a-c illustrate a vehicle with a temperature controlled compartment formed in accordance with the invention;

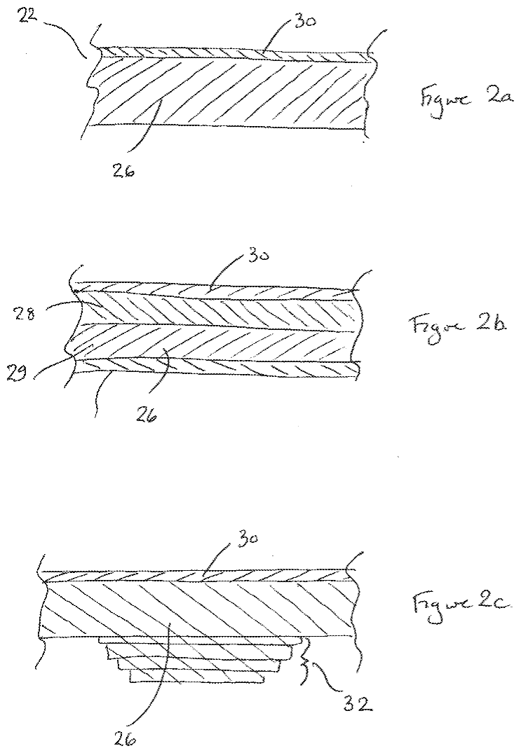

FIGS. 2a-c illustrate embodiments of panels in cross-section formed in accordance with the invention; and

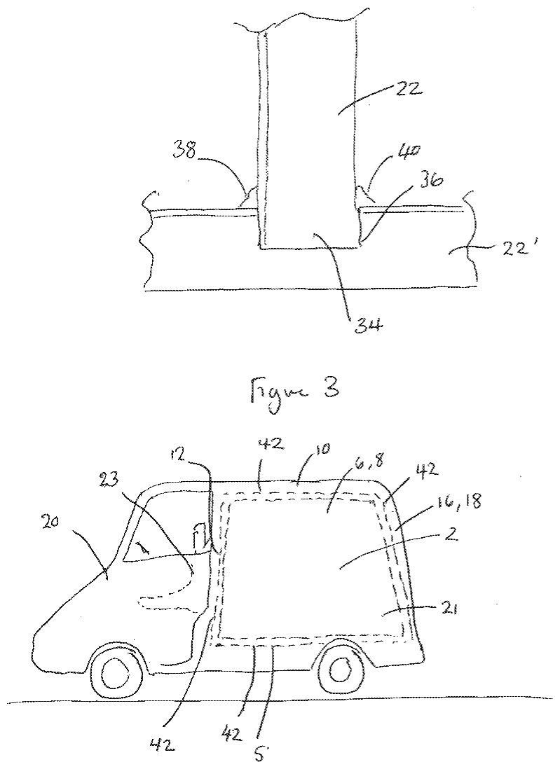

FIG. 3 illustrates in cross-section, a join between respective panels used to form said chamber.

Referring firstly to FIGS. 1a-c, there is illustrated a cavity 2 of a temperature controlled, typically chilled, environment compartment 4 formed by a series of walls comprising a floor 5, side walls 6,8, a ceiling or roof 10, end wall 12, and opposing end wall 14 which, in this case, is formed by the doors 16,18 of the vehicle 20 in which the compartment is formed in the storage area 21 of the vehicle which is typically located to the rear of the seats 23 of the vehicle. FIG. 1 b illustrates the rear of the vehicle 20 and FIG. 1c illustrates a typical form of vehicle in which the compartment in accordance with the invention can be provided. It will be appreciated that the compartment 4 may be at least partially formed externally of the storage area of the vehicle as illustrated in FIG. 1a before then being installed into the storage area 21 of the vehicle

In accordance with the invention, each of the walls, roof and floor is formed by one or a plurality of panels 22 formed in accordance with the invention and the said panels act to provide an insulating effect which is sufficient to maintain the chilled environment in the cavity 2 either at a temperature to allow the storage of goods to be held in a chilled condition or, for goods to be held in a frozen condition for a predetermined period of time, typically during transport of the goods from a first to a second location and in particular, with regard to goods in the form of foodstuffs.

In order to ensure that the chilled environment is maintained, there is provided a refrigerating unit 24 which, in this case, is located within the cavity but alternatively, could be provided on the roof or otherwise externally of the vehicle.

Furthermore, the chilled environment is provided in a vehicle which is preferably driven by electrical power and the electrical power is also used to operate the chilling apparatus.

Referring now to FIGS. 2a-c, there is illustrated in cross-section, different forms of panels which can be used in accordance with the invention.

In each of the embodiments, the panel 22 comprises a core 26 which, in the embodiments of FIG. 2a is a single layer core and in FIG. 2b, is a core 26 formed of two layers 28,29 with in this embodiment, one of the layers 28 having a greater rigidity, density and/or strength than the other of the layers, 29.

In each embodiment, the core 26 is formed of a foamed plastics material such as recycled Polyethylene Terephthalate rPET which may be for example, recycled plastic bottles and is, itself recyclable.

In each of the embodiments, at least one outer surface of the core is formed by an sheet material layer, preferably a woven sheet material layer 30, which again, is preferably formed from a plastics material which is recyclable and which may also be formed of recycled plastics material. In one embodiment the sheet material is a thermoformed acrylonitrile butadiene styrene (ABS). Typically in this process the plastics sheet material is heated until it is malleable and then joined to the core surface and is effectively melted to a sufficient extent to allow the sheet material to melt into and form an integral structure with the core 26. In FIGS. 2 a and c, only the surface of the panel which is to form the internal wall surface of the chilled cavity, is provided with the sheet material 30 but in FIG. 2b, both surfaces are provided with the sheet sheet material.

Typically, the respective panels are joined together, by locating an edge 34 of one of the panels 22, in a channel 36 formed in another of panels 22 as indicated in FIG. 3. While the channel and the edge can be formed of dimensions so as to provide a degree of a friction fit it, is found that the thermal efficiency of the join is improved by providing a plastic material bead 38,40 on either side of the panel and along the interface between the same and in accordance with the invention, this is provided by performing a plastic welding operation along the said interface.

As shown in FIG. 2c the core may include a series of layers 32 formed to provide a protruding portion and give the surface of the panel a 3D effect and which can be shaped so as to fill a void or recess in the frame of the vehicle when the panel is in position. In this embodiment of FIG. 3c, the panel is provided to be located adjacent to a door and the door has recesses therein which will be filled by the protruding portion layers 32 of the panel when the panel is fitted adjacent thereto. This therefore ensures that additional material of thermal efficiency is provided as and when required to fill cavities in the internal frame of the vehicle in which the chilled environment is to be formed and thereby increase the thermal efficiency of the walls of the vehicle and hence in turn, reduce the work required to be performed by the chilling apparatus in order to maintain the chilled environment in the required condition.

The panels can be shaped and interlinked so as to match the shape of the particular storage area 21 of the vehicle into which the compartment is to be formed, as shown for example in FIGS. 1b and c. Most typically the panels will be located adjacent to the interior faces 42 of the vehicle frame so as to provide the cavity 2 with a storage space which as closely as possible matches the storage space of the storage area 21 of the vehicle whilst, at the same time providing an efficient temperature controlled cavity and one which is formed of wholly recyclable materials.

This invention therefore minimises the waste material created when the compartment 2 and/or vehicle 20 reaches end of life and therefore, as a whole, greatly reduces the environmental impact of the vehicle and operation of the same in comparison with conventional vehicles of this type. As the structure of the panels is less heavy than conventional panels and, as a result, the vehicle is less heavy and the thermal efficiency of the panels is improved so the refrigeration unit is required to work less hard to achieve the chilling effect in the cavity and so the vehicle requires less power to operate which, in turn, makes the use of electrically powered vehicles realistic and/or reduces the usage of conventional fuels.

1. A vehicle compartment with a cavity in which there is provided a temperature controlled environment for the transport and/or storage of items therein, said compartment formed by a plurality of panels and wherein at least one of said panels includes a core formed of recycled and/or recyclable plastics material in a foamed condition and, on at least one external face of said core, there is provided an outer layer of sheet material bonded to said external surface of said core.

2. A vehicle compartment according to claim 1 wherein the said sheet material is a woven sheet material.

3. A vehicle compartment according to claim 2 wherein the panel is recyclable whilst the said sheet material is in situ with the said core.

4. A vehicle compartment according to claim 1 wherein the core is formed as a unitary structure.

5. A vehicle compartment according to claim 1 wherein the core is formed by at least two layers of material, a first layer having a rigidity and/or strength greater than that of the said second and any further layers.

6. A vehicle compartment according to claim 1 wherein a plurality of said panels are formed of the said core with said outer layer of sheet material.

7. A vehicle compartment according to claim 6 wherein a plurality of said panels include one or more channels formed therein, said channels provided to receive therealong a respective edge of another of said panels to form an interface and locate the edge in a specific orientation.

8. A vehicle compartment according to claim 7 wherein the specific orientation is such as to locate the first panel in which the channel is provided at substantially 90 degrees to the panel with the edge which is located along said channel.

9. : A vehicle compartment according to claim 7 wherein the said interfaces between panels are substantially sealed by using a plastics welded material along said interface.

10. A vehicle compartment according to claim 9 wherein the said plastics welded material is of a form so as to be recyclable along with the materials used to form the said panels.

11. A vehicle compartment according to claim 1 wherein in the said compartment there is provided a cavity which is defined by a floor panel, first and second side wall panels, a roof panel, an end wall panel and one or more door panels which form an opposing end wall when closed.

12. A vehicle compartment according to claim 11 wherein any of the floor panel, first and second side walls panels, roof panel and end wall panel are formed by a plurality of panels which are sealed together.

13. A vehicle compartment according to claim 11 wherein the panels are oriented such that said sheet material layer is located so as to form the surfaces of the respective panels which face inwardly into the cavity and hence act as contact faces with items located in the cavity.

14. A vehicle compartment according to claim 1 wherein said panels includes first and second opposing faces and edge faces and at least one of said panels includes, on at least one of said opposing faces, at least one protruding portion which acts as a means for location of the panel with the vehicle, and/or means of increasing the thermal efficiency of the panel at said location of the at least one protruding portion.

15. A vehicle compartment according to claim 14 wherein the said protruding portion is located on the face of the panel which faces towards a frame of the vehicle and is located in a recess in the frame of the vehicle to substantially fill the same and increase the thermal efficiency of the compartment.

16. A vehicle compartment according to claim 1 wherein the compartment is located in a storage area of the vehicle and the said panels are located adjacent to the walls of the said storage area.

17. A vehicle compartment according to claim 16 wherein the said vehicle is a van and the storage area is located to the rear of the driver and passenger seats of the said vehicle.

18. A vehicle compartment according to claim 16 wherein the said compartment is at least partially assembled at a location separate to the vehicle and then fitted into a storage area of the vehicle.

19. A vehicle compartment according to any of the claim 16 wherein the compartment is formed by placing the panels and joining the same together inside the storage area of the vehicle.

20. A vehicle compartment according to claim 16 wherein the compartment is provided in the storage area of the vehicle at an instant of time after the vehicle and storage area has been formed.

21. A panel for use in the creation of a compartment for a vehicle, said panel comprising a core formed of recycled and/or recyclable plastics material in a foamed condition and, on at least one external face of said core, there is provided an outer layer of sheet material bonded to said external face.

22. A panel according to claim 21 wherein the sheet material is formed as a woven, recyclable plastics material layer and the core and sheet material layer are recyclable as a unit.

23. A panel according to claim 21 wherein said panel includes first and second opposing faces and edge faces, with the opposing faces substantially parallel.

24. A panel according to claim 21 wherein said panel includes first and second opposing faces and edge faces and at least one of the said opposing faces is formed with at least one protruding portion which acts as a means for location of the panel and/or means of increasing the insulating effect of the panel at said location of the at least one protruding portion.

25. A vehicle including a storage area and in which there is provided a compartment with a cavity in which a chilled environment is provided, said compartment formed in accordance with claim 1.

26. A vehicle according to claim 25 wherein the vehicle includes at least one refrigeration unit provided in, or connected to, the cavity of the compartment to introduce cooling air into the said cavity.
